(19) United States
(12) Patent Application Publication
(10) Pub. No.: US 2014/0029921 A1
(43) Pub. Date: Jan. 30, 2014

(54) SYSTEMS AND METHODS FOR HOTSPOT ENABLED MEDIA

(71) Applicants: ADAM WARREN, Keller, TX (US); BAO TRUONG, St. Charles, MO (US); DAVE MERCADO, San Pedro (PH)

(72) Inventors: ADAM WARREN, Keller, TX (US); BAO TRUONG, St. Charles, MO (US); DAVE MERCADO, San Pedro (PH)

(21) Appl. No.: 13/953,566

(22) Filed: Jul. 29, 2013

Related U.S. Application Data
(60) Provisional application No. 61/676,874, filed on Jul. 27, 2012.

(51) Int. Cl. G11B 27/031

(52) U.S. Cl. CPC G11B 27/031
USPC 386/282

(57) ABSTRACT

Methods and systems for managing hotspot objects associated with one or more videos are disclosed. A hotspot editor is displayed to a user, the hotspot editor includes a video area, a control area, and a hotspot data area. A first hotspot object region is defined for the first time in the first video based on the first coordinate set. A second hotspot object region is defined for the second time in the first video based on the second coordinate set. One or more hotspot object regions are determined for the first hotspot object for one more times between the first time and the second time. The first hotspot object is associated with a first address. Data associated with the first hotspot object is stored, wherein the data associated with the first hotspot object includes the hotspot regions and the associated first address.

### CROSS-REFERENCE TO RELATED APPLICATIONS

This application claims priority to U.S. provisional patent application Ser. No. 61/676,874, filed Jul. 27, 2012, entitled “Systems And Methods For Online Operating System Powered By A Video Game; Media Player Usable On An Online Operating System,” by Adam Warren, Abdallah Johnny Chammas, Timothy James Myers, Bao Truong, Adiodun Adewale Johnson, the contents of which are incorporated by reference herein.

### BACKGROUND

Digital technologies, such as digital cameras, video recorders, and smart phones have created a wealth of media available to users on the user's local device and on the Internet. A simplified and robust mechanism for creating, editing, and playing multimedia content which provides user interactivity for the digital technologies is desirable.

### SUMMARY OF THE INVENTION

Embodiments of the present disclosure include methods, systems, and computer executable instructions stored in a non-transitory tangible medium for managing hotspot objects associated with one or more videos. The methods include displaying a hotspot editor to a user. The hotspot editor includes a video area, a control area, and a hotspot data area. The methods include receiving from the user a first coordinate set associated with a first hotspot object at a first time in a video. The methods include defining a first hotspot object region for the first time in the video based on the first coordinate set. The methods include receiving from the user a second coordinate set associated with the first hotspot object at a second time in the video clip. The methods include defining a second hotspot object region for the second time in the video based on the second coordinate set. The methods include determining one or more hotspot object regions for the first hotspot object for one more times between the first time and the second time. The methods include associating the first hotspot object with a first address. The methods include storing data associated with the for the first hotspot object, wherein the data associated with the first hotspot object includes the hotspot regions and the associated first address.

Embodiments of the present disclosure include methods, systems, and computer executable instructions stored in a non-transitory tangible medium for managing a multi-angle hotspot-enabled set of videos. The method includes loading a video manager, wherein the video manager is configured to selectively stream and play a first video and a second video. The methods include loading a hotspot project, the hotspot project including one or more hotspot objects, wherein at least one of the hotspot objects is associated with both the first video and the second video and wherein each of the hotspot objects has an associated address and one or more associated hotspot regions. The method includes receiving and playing the first video from a server. The method includes receiving a command from the user to play the second video and, in response to the command saving a current time in the first video; pausing the first video. Furthermore, if the first video has not been fully streamed, the method includes stopping the streaming the first video. The methods include loading the second video, seeking to the current time, play the second video. The method further includes receiving a selection from the user for a hotspot object. The methods further include determining, based on the selection from the user and the one or more hotspot regions, a selected hotspot object. The methods include sending the user to the address associated with the selected hotspot object.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which a media player usable on a social network platform can be achieved;

FIG. 1B is a block diagram of an exemplary computing environment through which a media player usable on a social network platform can be achieved;

FIG. 1C is an illustrative architectural diagram showing some structure that can be employed by devices through which a media player usable on a social network platform is achieved;

FIG. 2 is an exemplary diagram of a server in an implementation suitable for use in a system where a media player usable on a social network platform is achieved;

FIG. 3 is an exemplary diagram of a master system in an implementation suitable for use in a system where a media player usable on a social network platform is achieved;

FIG. 4 is a block diagram showing the cooperation of exemplary components of a system suitable for use in a system where a media player usable on a social network platform is achieved; and

FIGS. 5A-C, 6A-C, 7, 8, and 9 are screen shots of example hotspot editor applications and hotspot-enabled payer applications;

FIGS. 10 and 12 are flowcharts of example embodiments of the present disclosure; and

FIG. 11 is a block diagram of an example hotspot project.

### DETAILED DESCRIPTION

Example implementation of the systems and methods described herein use one or more computer systems, networks and/or digital devices. Example systems and methods disclosed herein are enabled as a result of one or more application running on a computing system.

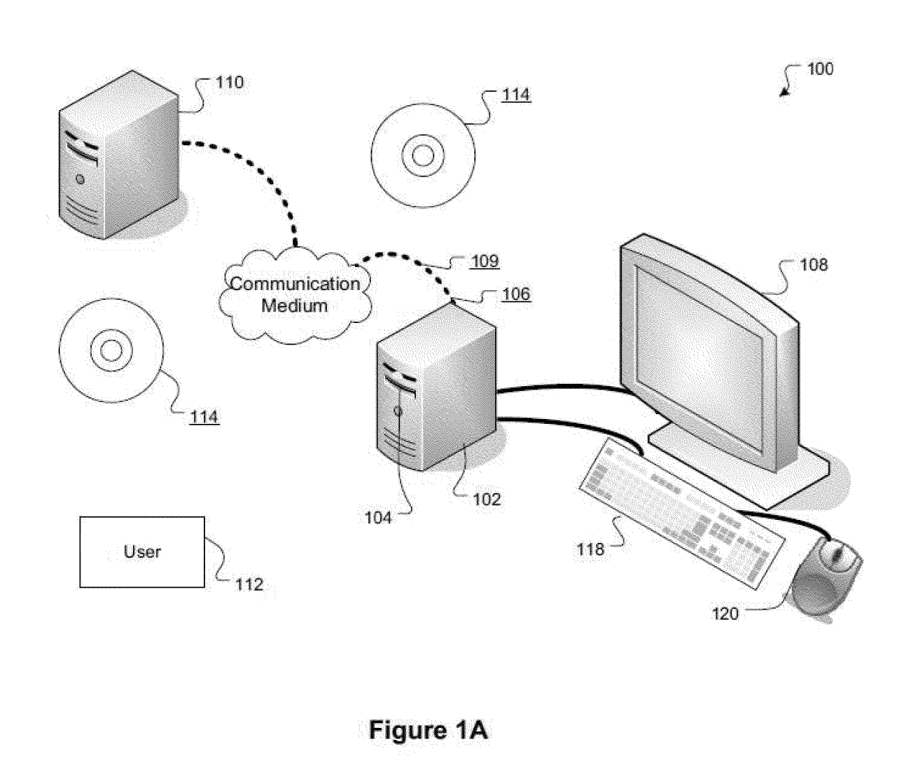

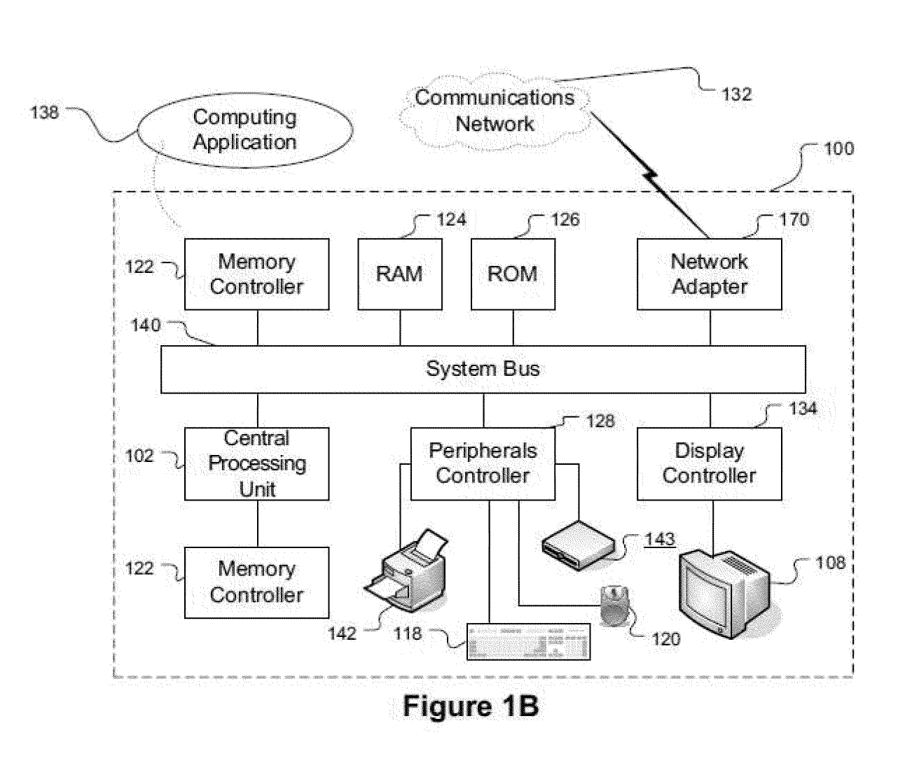

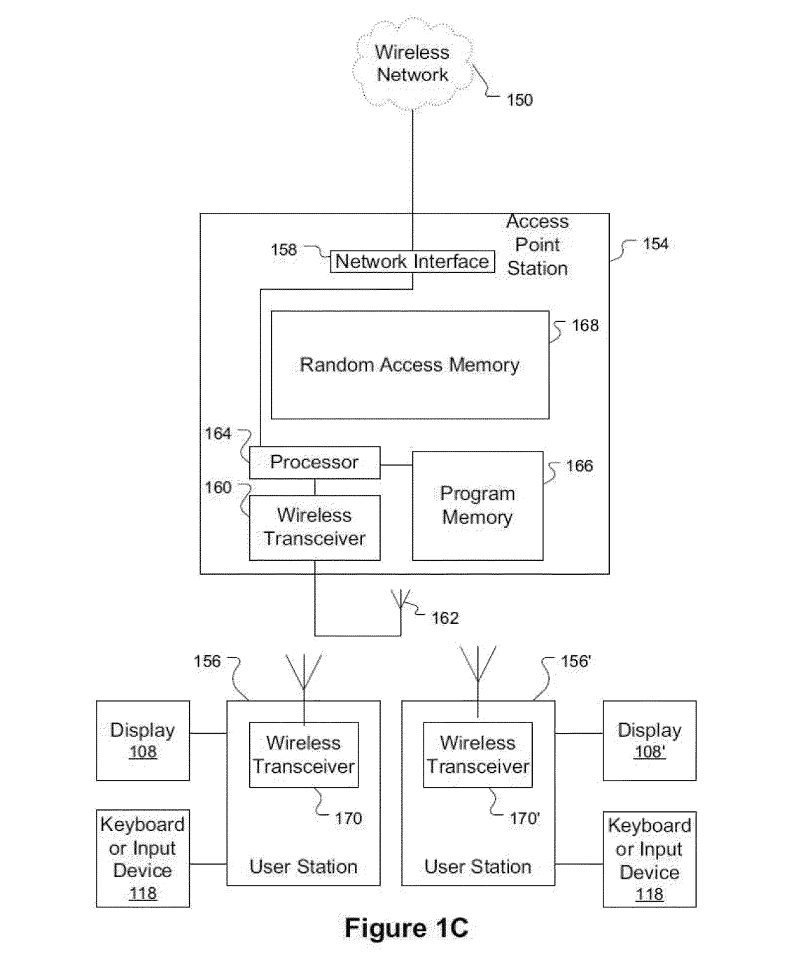

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system is adaptable to communicate with other computers over the Internet, or with computers via a server.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components to generate a video signal that is sent to display 108. Further, the computing system 100 can contain network adaptor 136 which may be used to connect the computing system 100 to an external communications network 132.

The Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems and technical effect of this invention, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

In IEEE P802.21/D.01.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

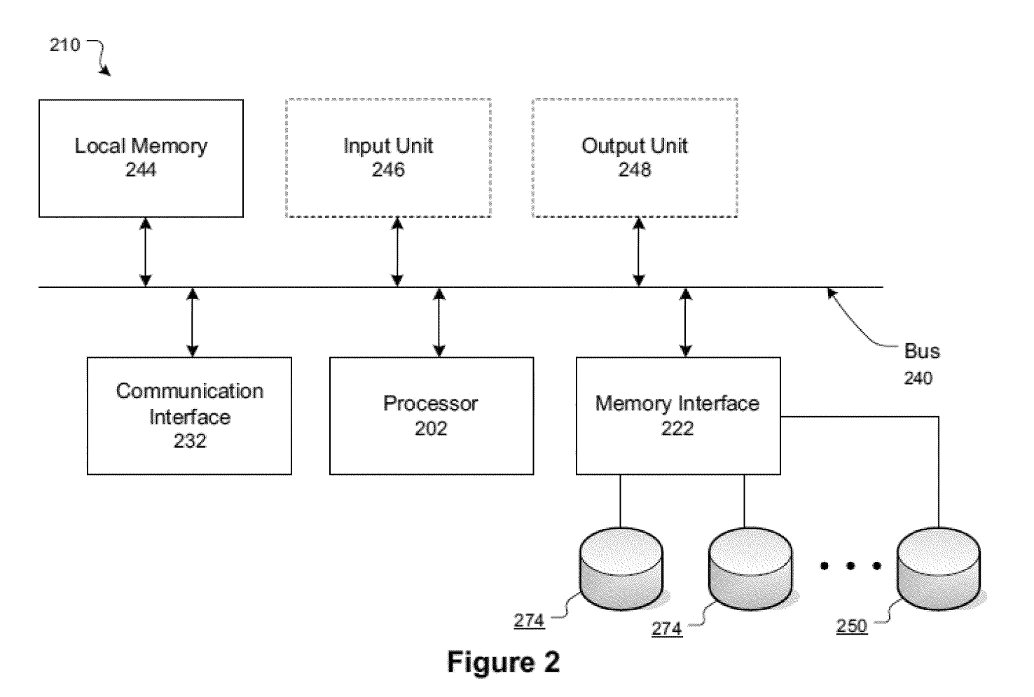

FIG. 2 is an exemplary diagram of a server 210 in an implementation consistent with the principles of the disclosure to achieve the desired technical effect and transformation. Server 210 may include a bus 240, a processor 202, a local memory 244, one or more optional input units 246, one or more optional output units 248, a communication interface 232, and a memory interface 222. Bus 240 may include one or more conductors that permit communication among the components of chunk server 250.

Processor 202 may include any type of conventional processor or microprocessor that interprets and executes instructions. Local memory 244 may include a random access memory (RAM) or another type of dynamic storage device that stores information and instructions for execution by processor 202 and/or a read only memory (ROM) or another type of static storage device that stores static information and instructions for use by processor 202.

Input unit 246 may include one or more conventional mechanisms that permit an operator to input information to a server 110, such as a keyboard 118, a mouse 120 (shown in FIG. 1), a pen, voice recognition and/or biometric mechanisms, etc. Output unit 248 may include one or more conventional mechanisms that output information to the operator, such as a display 134, a printer 130 (shown in FIG. 1), a speaker, etc. Communication interface 232 may include any transceiver-like mechanism that enables chunk server 250 to communicate with other devices and/or systems. For example, communication interface 232 may include mechanisms for communicating with master and clients.

Memory interface 222 may include a memory controller 122. Memory interface 222 may connect to one or more memory devices, such as one or more local disks 274, and control the reading and writing of chunk data to/from local disks 276. Memory interface 222 may access chunk data using a chunk handle and a byte range within that chunk.

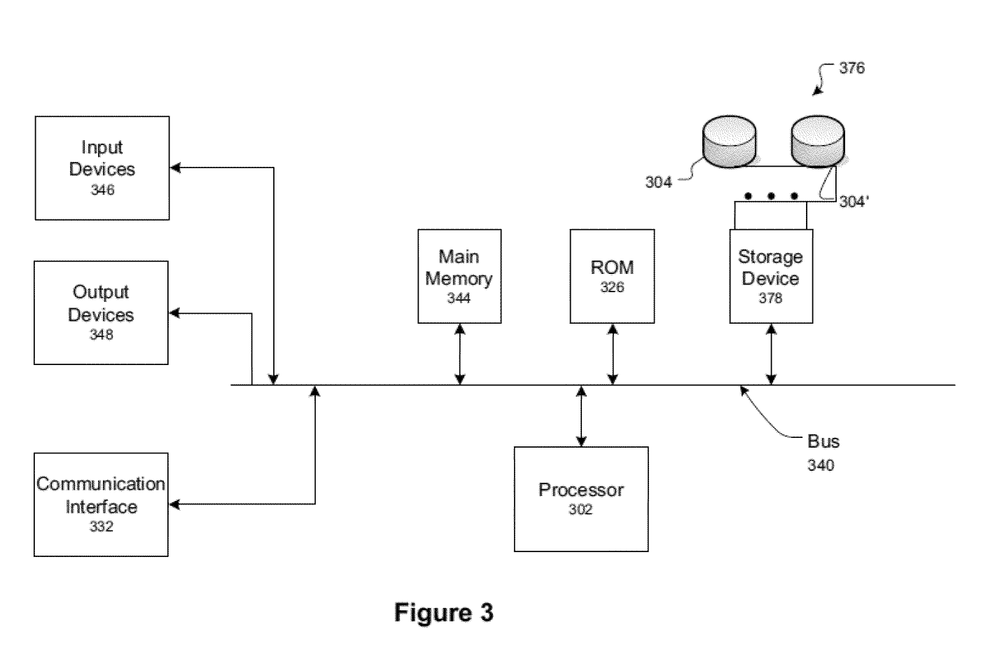

FIG. 3 is an exemplary diagram of a master system 376 suitable for use in an implementation consistent with the principles of the disclosure to achieve the desired technical effect and transformation. Master system 376 may include a bus 340, a processor 302, a main memory 344, a ROM 326, a storage device 378, one or more input devices 346, one or more output devices 348, and a communication interface 332. Bus 340 may include one or more conductors that permit communication among the components of master system 374.

Processor 302 may include any type of conventional processor or microprocessor that interprets and executes instructions. Main memory 344 may include a RAM or another type of dynamic storage device that stores information and instructions for execution by processor 302. ROM 326 may include a conventional ROM device or another type of static storage device that stores static information and instructions for use by processor 302. Storage device 378 may include a magnetic and/or optical recording medium and its corresponding drive. For example, storage device 378 may include one or more local disks that provide persistent storage.

Input devices 346 used to achieve the desired technical effect and transformation may include one or more conventional mechanisms that permit an operator to input information to the master system 374, such as a keyboard 118, a mouse 120, (shown in FIG. 1) a pen, voice recognition and/or biometric mechanisms, etc. Output devices 348 may include one or more conventional mechanisms that output information to the operator, including a display 108, a printer 142 (shown in FIG. 1), a speaker, etc. Communication interface 332 may include any transceiver-like mechanism that enables master system 374 to communicate with other devices and/or systems. For example, communication interface 332 may include mechanisms for communicating with servers and clients as shown above.

Master system 376 used to achieve the desired technical effect and transformation may maintain file system metadata within one or more computer readable mediums, such as main memory 344 and/or storage device.

The computer implemented system provides a storage and delivery base which allows users to exchange services and information openly on the Internet used to achieve the desired technical effect and transformation. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

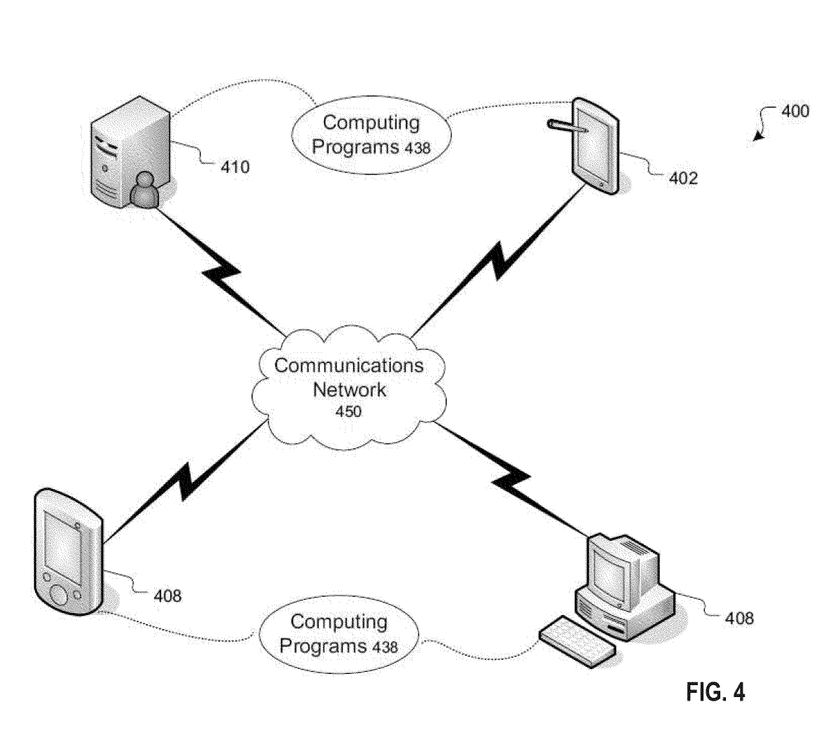

Computing system 100, described above, can be deployed as part of a computer network used to achieve the desired technical effect and transformation. In general, the above description for computing environments applies to both server computers and client computers deployed in a network environment. FIG. 4 illustrates an exemplary illustrative networked computing environment 400, with a server in communication with client computers via a communications network 450. As shown in FIG. 4, server 410 may be interconnected via a communications network 450 (which may be either of, or a combination of a fixed-wire or wireless LAN, WAN, intranet, extranet, peer-to-peer network, virtual private network, the Internet, or other communications network) with a number of client computing environments such as tablet personal computer 402, smart phone 404, personal computer 402, and personal digital assistant 408. In a network environment in which the communications network 450 is the Internet, for example, server 410 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 400 can utilize various data security protocols such as secured socket layer (SSL) or pretty good privacy (PGP). Each client computing environment can be equipped with operating system 438 operable to support one or more computing applications, such as a web browser (not shown), or other graphical user interface (not shown), or a mobile desktop environment (not shown) to gain access to server computing environment 400.

In operation, a user (not shown) may interact with a computing application running on a client computing environment to obtain desired data and/or computing applications. The data and/or computing applications may be stored on server computing environment 400 and communicated to cooperating users through client computing environments over exemplary communications network 450. The computing applications, described in more detail below, are used to achieve the desired technical effect and transformation set forth. A participating user may request access to specific data and applications housed in whole or in part on server computing environment 400. These data may be communicated between client computing environments and server computing environments for processing and storage. Server computing environment 400 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

One example implementation of the present disclosure includes a hotspot editor application to create or modify hotspot objects associated with video. Another example implementation of the present disclosure includes a hotspot-enabled video player that is configured to play video files that have associated hotspot objects. Another example embodiment allows the user to create or modify one or more hotspot objects in a picture.

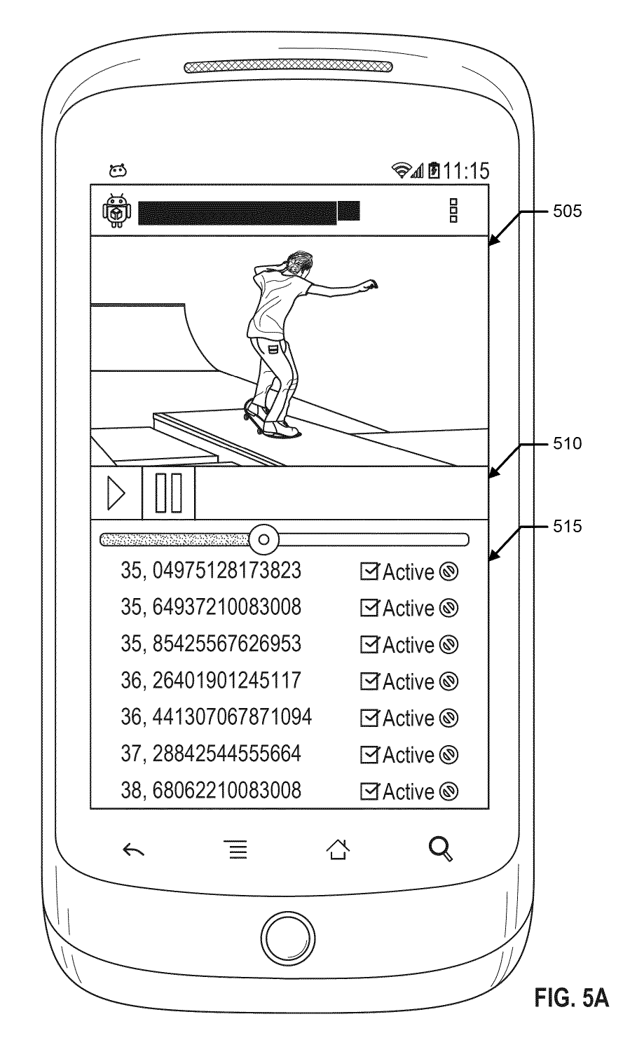

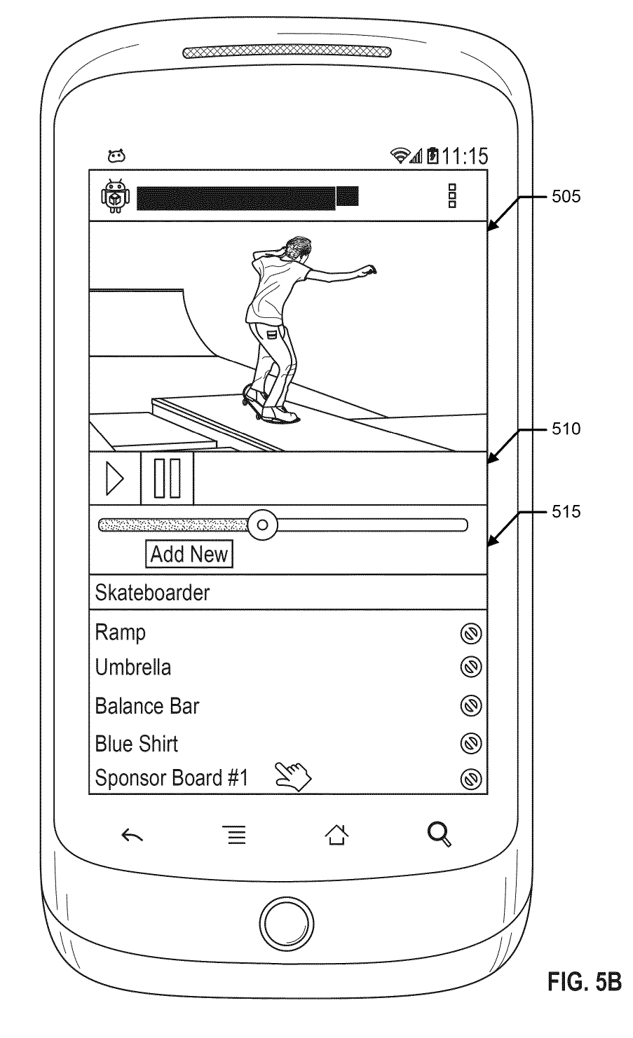

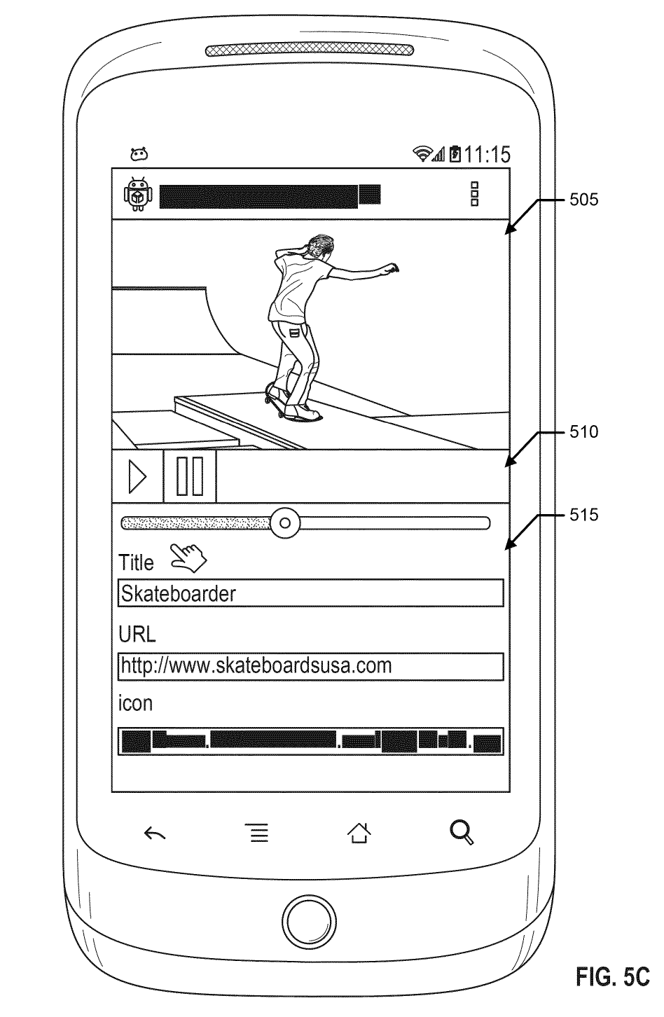

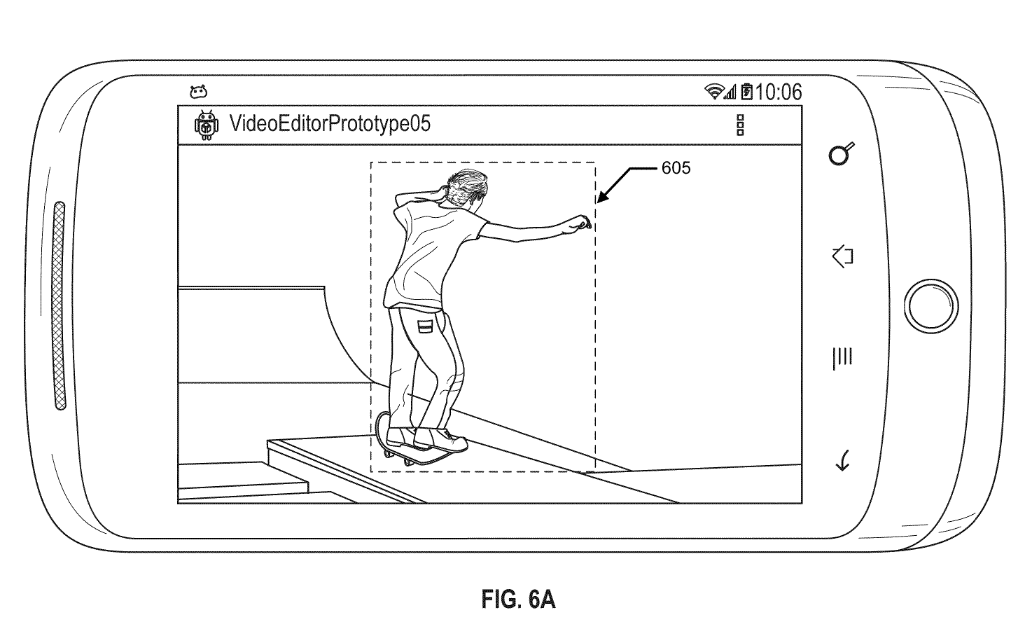

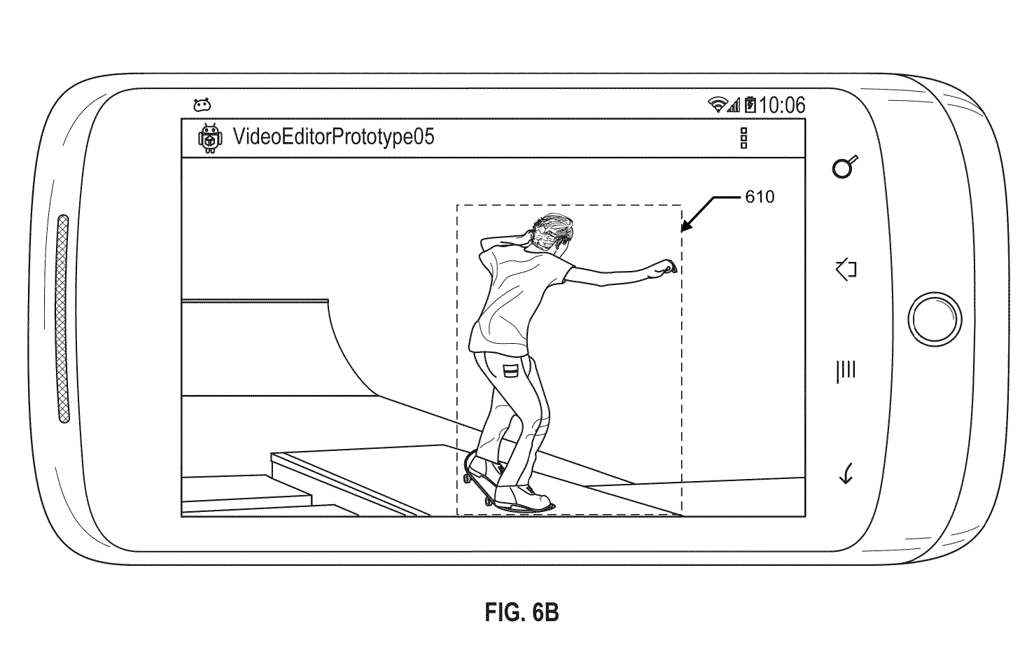

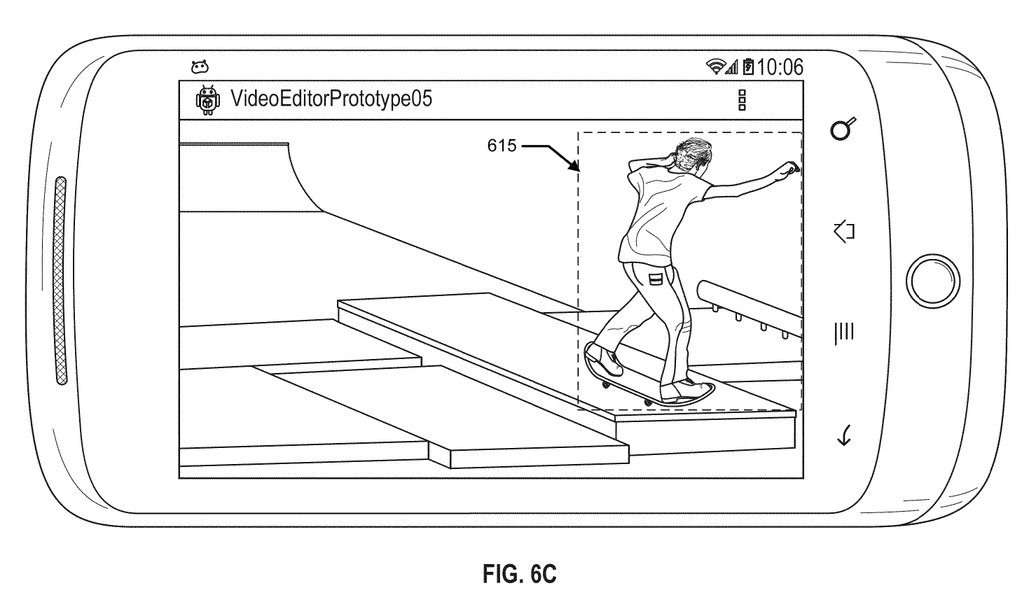

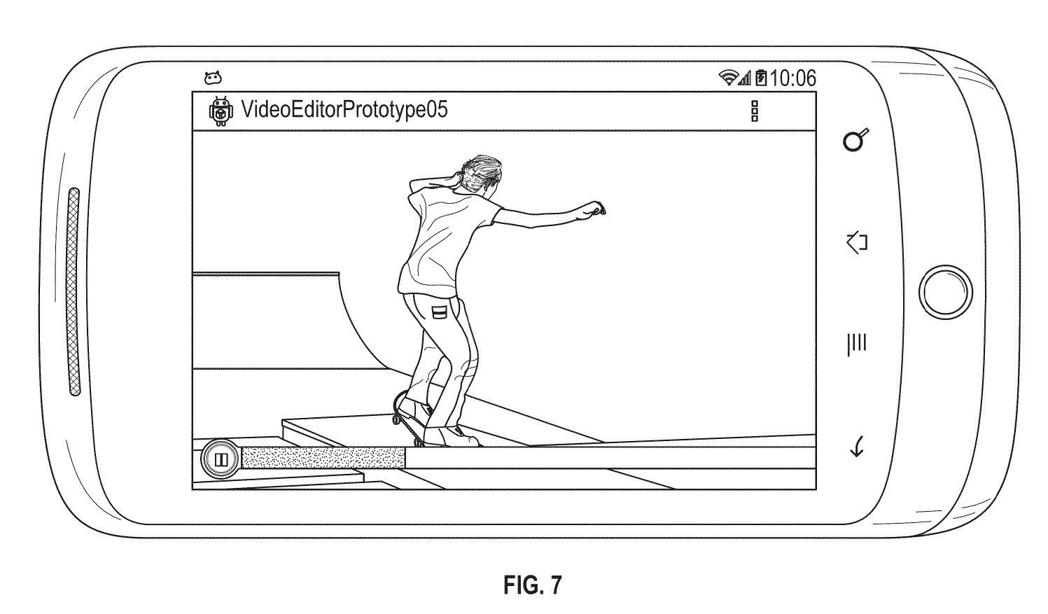

FIG. 5A is a screen shot of an example hotspot editor application according to the present disclosure. The hotspot editor application includes a video area 505, a controls area 510, and a hotspot data area 515. In certain implementations, the video area 505 is configured to display the video being edited. In some implementations where user input via touch is enabled, the video area 505 is further configured to receive user touch input. For example, the video area 505 may include a transparent or semi-transparent area that is configured to show the active hotspots that the user may modify in a frame of the video. In certain implementations, the transparent drawable area of the video area 505 is further configured to receive user input when the user drags the user's finger across the transparent drawable area to define one or more of a circle, a rectangle, an irregular shape around an object in the video area 505.

Example control area 510 includes widgets for navigating or controlling the video played in video area 505. The example control area 510 includes a play button, a pause button, and a tracking and progress bar. A user will find the widgets in the control area exhibit expected behavior. For example, the play and pause buttons cause the video displayed in the video area 505 to play or pause, respectively. Similarly, the a tracking and progress bar may be used for fine tracking of the video by allowing the user to move the video forward or back by moving the circle to a different location on the progress bar. The progress bar displays the time position in the video.

Hotspot information area 515 displays information regarding the hotspots associated with the video show in video area 505. In certain implementations, the hotspot information area 515 displays the contents of a hotspot database associated with the video. The structure of the hotspot database will be discussed in greater detail below. In order to show the hotspot information to the user, certain implementations feature two or more screens to show the hotspot information. For example, in FIGS. 5A, 5B, and 5C, the user may switch between the hotspot information areas 515 shown in each of FIGS. 5A, 5B, and 5C. In certain implementations, the user can scroll between hotspot information areas 515 shown in each of FIGS. 5A, 5B, and 5C by swiping a touch screen. In other implementations, the user clicks a button to switch between hotspot information areas 515 shown in each of FIGS. 5A, 5B, and 5C.

The hotspot information area 515 shown in FIG. 5A displays a list of hotspot times for a hotspot object and a selectable indicator of whether or not the hotspot object is active at the time. In the case of FIG. 5A the checkmarks indicate that the hotspot object is active for the times shown in the display of hotspot information area 515. In certain implementations, the user may make a hotspot object inactive for one or more times by unchecking the box beside the hotspot time. This may be useful, for example, when the hotspot object is not visible in the video at time indicated in the hotspot information area 515. For example, if the hotspot object corresponds to the skateboarder's shirt and the video pans away from the skateboarder at time 37,28842544555664, then the user may choose to make the hotspot inactive for the selected time.

Turning to FIG. 5B, the hotspot information area 515 now show a list of hotspot objects for the video displayed in video area 505. The user can select one of the hotspot objects to edit by clicking or touching the name of the hotspot object. The screen shows that the hotspot object entitled “Skateboarder” is currently being edited. The user may add a new hotspot object using the “Add New” button. In certain example embodiments, the user will be prompted enter one or more pieces of hotspot information shown in the hotspot information area 515 in FIG. 5C after adding a new hotspot object.

Turning to FIG. 5C, the hotspot information area 515 shows a title or name, address, and icon associated with the selected hotspot object. The user may assign a name or title to the hotspot object using an input device. In certain example implementations, the program may suggest a title based, for example, on the content of the video or based on the title of other hotspot objects associated with the video. In other example implementations, the program automatically assigns a title to the new hotspot object. The hotspot object is also associated with an address. In some example implementations, the address is a Uniform Resource Locator (URL), such as the address of a web page associated with the hotspot object. In some example implementations, the address is a telephone number. In some example implementations, the address is a physical address. In some example implementations, the address is a command to launch a stand-alone application. In some example implementations, information at the address can provide further details on the hotspot object, such as the features or benefits of the hotspot object. In other example implementations, the information at the address allows a user to purchase an item or service associated with the hotspot object. In some implementations, the user associates the address with the hotspot object by entering the address using an input device. In other implementations, using a web browser or other application, the user navigates to an address that the user wants to associate with the hotspot object and indicates that the navigated address should be associated with the hotspot object. In other implementations, the editor application includes an integrated search option. In these implementations, the user enters one or more terms. These terms are communicated to a server which, in turn, may consult one or more data sources to determine one or more search results in response to the user's queried terms. For example, the server may send JSON, SOAP, or REST queries to one or more data sources, such as vendors, to find one or more results corresponding to the search terms. The server then returns one or more results to the editor application, which, in turn, displays the search results to the user. The user may then select one or more of the search results to associate with the hotspot object. One or more addresses associated with the selected search results are then associated with the hotspot object.

As shown in FIG. 5C, in certain implementations, the user associates an icon with the hotspot object. The user may choose whether the icon will be visible or not visible in one or more times in the video. In certain implementation, the user chooses or alters the placement of the icon on the screen for one or more times. For example, the user may want a visible icon on the skateboarder's shirt and may want it to be place at a chosen location for a first time in the video.

Using the editor application shown in FIGS. 5A-5C, the user may select one or more regions in the video to identify as hotspot regions for a given hotspot object for a given time in the video. In one example implementations, the region for identification is selected by specifying two coordinates to specify a rectangular area. In one implementation, the upper left hand corner and lower right hand corner of a rectangle are the coordinates used to define the hotspot. In one example implementation, the user taps on two coordinates using a touch input device to identify the coordinates of the hotspot. In another example implementation, the user, using a touch input device, may press on a first coordinate and drag the user's finger to the second coordinate to define the hotspot region. In other example implementations, the user uses a mouse to specify the coordinates of the hotspot region. In an example implementation the user, using an input device, such as a mouse, trackball, or keyboard, moves a cursor to a first location and indicates that the location is the first coordinate of the region by clicking the mouse. The user, using the mouse, may move the cursor to a second location and indicate that the second location is the second coordinate of the region by clicking a mouse button. In another example implementation, the user may use a keyboard to specify the coordinates of the hotspot region. In one example implementation, the user uses, for example, arrow keys on the keyboard or other tactile input device to move a cursor to the first and second coordinates of the hotspot region and another key on the keyboard or other tactile input device, for example the enter key, to signal that the two locations on the screen are the coordinates of the hotspot region. In yet another example implementation, the user may specify one or more of the coordinates by typing values corresponding to the X and Y coordinates of the locations for selection as the hotspot region.

In other example implementations, hotspot regions may be defined by a user specifying one or more circles. For each of the circles, the user may specify the center of the circle by touching or clicking on the location to be the center of the circle and touch or clink on another location to specify the radius of the circle. In another implementation, after touching or clicking on the location to be the center of the circle, the user may drag their finger to a location to specify the radius of the circle. In another example implementation, the user may use a mouse to click on a location to be the center of the circle and click on another location to specify the radius of the circle.

In other example implementations, the user may specify hotspot regions by specifying three or more locations around the hotspot region to define an irregular shape. For example, with respect to FIGS. 5A-5C, the user may touch or click on three, four, five, six, or more locations around the shirt of the skateboarder to define a hotspot region for the shirt. This technique will allow the user to define the hotspot regions in greater detail. In certain implementations, the user may selectively use or more of hotspot region identification mechanisms. For example, for one hotspot object region, the user may choose to specify the hotspot by specifying two coordinates to define a rectangle. For a second hotspot object region, the user may choose to specify one or more circles by specifying a center and a radius of the circle. For a third hotspot object region, the user may choose to specify three or more points around the hotspot region to form an irregular shape to define the hotspot region.

In certain example implementations, the editor application provides visual feedback to the user while the hotspot region is being selected. In one example implementation, the editor may shade the hotspot region being selected. In another example implementation, the editor may display a border around the region being selected as the hotspot region. In other example implementation, the application shows existing hotspot regions by shading or outlining the existing hotspot regions.

In certain implementations, once a region in the video is a hotspot region, the program displays an icon within the hotspot region. In certain implementations, the user may click on the icon to edit the hotspot object. In other implementations, the user may click on the icon to go to an address associated with the hotspot.

Turning to FIGS. 6A, 6B, and 6C, an example implementation of creating hotspot regions for a hotspot object are shown. A hotspot object is created for the skateboarder in FIGS. 6A, 6B, and 6C. As described with respect to FIGS. 5A, 5B, and 5C the skateboarder object may be associated with a title, and address or URL, and one or more hotspot regions, each region corresponding to a time in the video. FIGS. 5A, 5B, and 5C are at different, progressively later, times in the video. In one example embodiment, the user specifies hotspot region 605 in FIG. 5A by inputting two coordinates that define a rectangle. In one example embodiment the user specifies two opposite corners of the rectangle. In another example embodiment, the user may specify the center of the rectangle and maniple at sides to define the hotspot regions. The user may then specify hotspot region 615 for the time in FIG. 5C using one or more of the same techniques described above with respect to FIG. 5A. Recall that the image in FIG. 5B is between the images in FIG. 5A and FIG. 5C in time. In one example embodiment, the editor application determines the location of hotspot region 510 without user intervention. In one example embodiment, the editor application determines hotspot region 510, using hotspot regions 505 and 515 as endpoints, and the editor application calculates an intermediate location between the coordinates that define hotspot regions 505 and 515. For example, the hotspot editor application calculates the coordinates associated with hotspot region 510, based on linear movement between the first set of coordinates corresponding to hotspot region 505 and second set of coordinates corresponding to hotspot region 515. In another example embodiment, the hotspot editor application may assumes a semi-elliptical path between the first set of coordinates corresponding to hotspot region 505 and the second set of coordinates corresponding to hotspot region 515. In another example embodiment, the hotspot editor application may analyze the video to identify the object being tracked in hotspot regions 505 and 515.

In certain example embodiments, the user of the hotspot editor application may alter the hotspot region 510 that was determined or calculated by the hotspot editor application. For example, the user may correct for the actual motion of the object being tracked in the video. The user may continue to define three, four, five, or more hotspot regions for times in the video. The hotspot editor application then, in turn, calculates one or more hotspot regions for times between the times in the video for which the user has specified hotspot regions. As shown in FIG. 5A, the user may deactivate a hotspot object for one or more times in the video. This may be used, for example, where no image of the hotspot object appears at that time in the video.

The user may repeat the hotspot definition process for a two, three, or more hotspot objects associated with each video. With respect to FIGS. 5A, 5B, and 5C the user may define a first hotspot object and corresponding hotspot regions at one or more times for the skateboarder and a second hotspot object and corresponding hotspot regions at one or more times for the shirt worn by the skateboarder. The user may create a third hotspot object and corresponding hotspot regions for the ramp.

In certain example embodiments, when a portion of the video that is currently being displayed in video area 505 includes one or more visible hotspot regions, an icon may be displayed within or near the hotspot region. A user may control where the icon associated with the hotspot region is displayed, for example by selecting a location or dragging the icon.

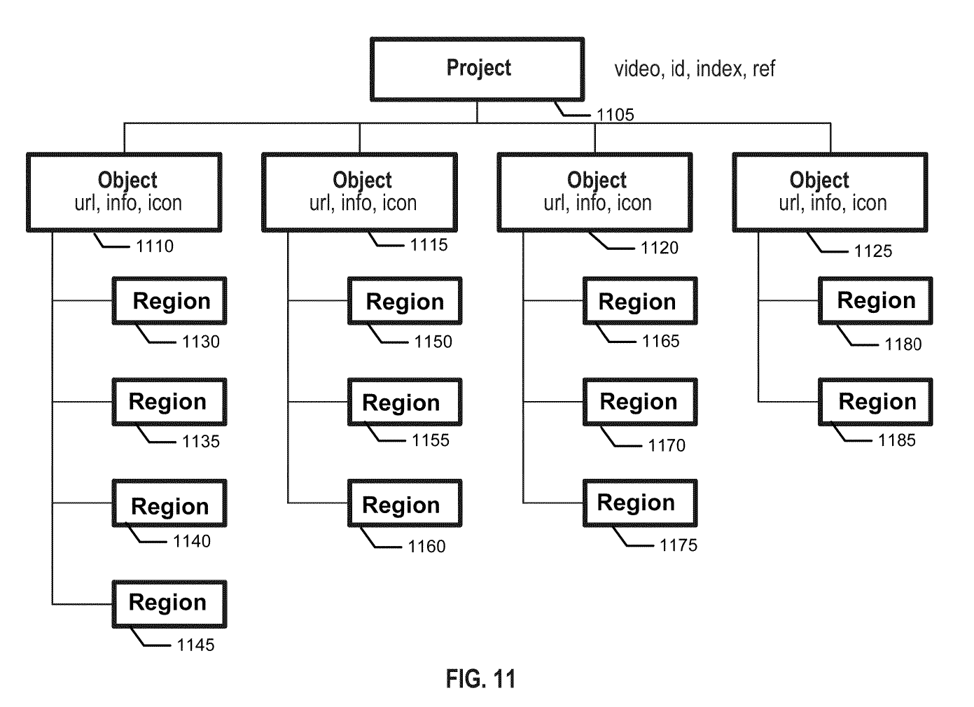

FIG. 11 is a block diagram of hotspot information that is stored by an example hotspot editor application and read by example hotspot player applications. A hot spot project 1105 is associated with one or more videos, which may correspond to video streams, video files, or still images. A video file may be a series of moving images or a video file may be a still picture. Still other video files may be one or more frames from a series of moving images. An example hotspot project 1105 may have one or more of an associated id, index, and reference. Within the project are one or more hotspot objects 1110-1125. Hotspot objects 1110-1125 are shown in FIG. 11. Each of hotspot objects 1110-1125 have one or more of an associated address (e.g., URLs, phone numbers, physical addresses), information, title, one more tags, and an icon. Each of the hotspot objects 1110-1125 is associated with one or more hotspot regions. In FIG. 11, hotspot object 1110 is associated with hotspot regions 1130-1145, hotspot object 1115 is associated with hotspot regions 1150-1160, hotspot object 1120 is associated with regions 1165-1175, and hotspot object 1125 is associated with hotspot regions 1180 and 1185. Each of regions 1130-1185 may be defined by one or more coordinates sets, such as x or y coordinates, one or more heights or widths, and one or more times or time ranges. Coordinates associated with hotspot regions 1130-1185 indicate the location of the hotspot region in one or more videos associated with project 1105. In certain example embodiments, the information corresponding to project 1105 is stored in a file. In some example systems, the information corresponding to project 1105 is stored in a binary format. In other example systems, the information corresponding to project 1105 is stored in an XML format.

In some example embodiments, the project 1105 may be associated with a plurality of video files. For example, there may be multiple videos of a single event or scene, with each video capturing a different angle of the event or scene. Embodiments of the disclosure include a video manager than controls two or more video players, where each video player is to play one of the videos. In certain embodiments, each video player has an associated buffer to store downloaded video. In some embodiments, each of the plurality of videos managed by the video manger is associated with a separate download source. The video manager controls which of the plurality of videos associated with project 1105 are downloaded and buffered at a time. Each video may be associated with one or more hotspot objects. In certain example embodiments, a hotspot object may exist in two or more of the videos. For example, in a multi-angle set of videos of the skateboarder of FIGS. 5A-5C, the skateboarder object may be associated with two or more videos where the skateboarder is visible. Hotspot information, such as the icon associated with the hotspot, the hotspot object name, and hotspot object address or URL may be shared between hotspot objects in a plurality of videos.

Certain embodiments of the video manager track the progress of each video player by time or percentage of completion. The video manager is configured to receive a command from a user to switch from a current video to another video. For example, in the case of a three-video set (corresponding to a three-angle shot of an event) the video manager displays three boxes to the user to allow the user to switch between videos, which may correspond to video angles of the event or scene. A user may select one of the three boxes to switch between the three videos. When a user initiates a change from a current video to a second video, the video manger stores the progress of the current video before switching to the second video. In certain embodiments, the video manager uses the progress of the previously-playing video to determine a location in the second video to being playing or streaming. In certain example embodiments, the video manger will find a nearest key frame in the selected video to begin playing. In other example embodiments, the video manger determines a nearest key frame that is at or behind the progress of the previously-playing video. In other example embodiments, the video manger determines a nearest key frame that is at or beyond the progress of the previously-playing video.

In some example embodiments, the video manger causes the currently selected video to be downloaded and buffered and the non-selected video to not be downloaded. In some example embodiments, when, as described above, the user chooses to go to a second video while watching a current video, the video manger stops the downloading of the current video and starts downloading and buffering the second video at the location of the current video, or at the location of a nearby key frame, as described above. For example, if the current video were at 1:17 and a user then selects a second video, an example video manger would request to start downloading and buffering the second video beginning at or near 1:17. Example embodiments of the video manager may choose to not buffer downloaded video to conserve memory. Embodiment of the video manger that buffer downloaded video give the user the ability to replay previously-displayed video without using additional bandwidth. In example embodiments where the bandwidth is sufficient to download and buffer video faster than it is displayed to the user, the video manager may download and buffer video for future playback to the user. In the case of a video manager with a plurality of videos, when the currently-displayed video is fully buffered, an example video manager begins downloading and buffering a second, third, or subsequent video.

Example embodiments of the video manager store additional information about each video player. For example, the video manager may retrieve and store metadata about the video associated with one or more of the video players in an array. Example embodiments of the video manager store, for each of the videos managed by the video manager one or more of: a video length, a video size, a current playhead position, a paused or unpaused status, an amount of data buffered for the video, a video frame rate, audio codec information, video codec information, key frame locations, and index information for the video. Storing metadata about the videos may decrease calls to remote application programming interfaces (APIs) to retrieve this information about the videos.

In the case of multi-angle video that includes one or more hotspots, when a user selects a location in a video, the video manager searches the hotspot objects associated with the current video for a hotspot region associated with at the selected location and time.

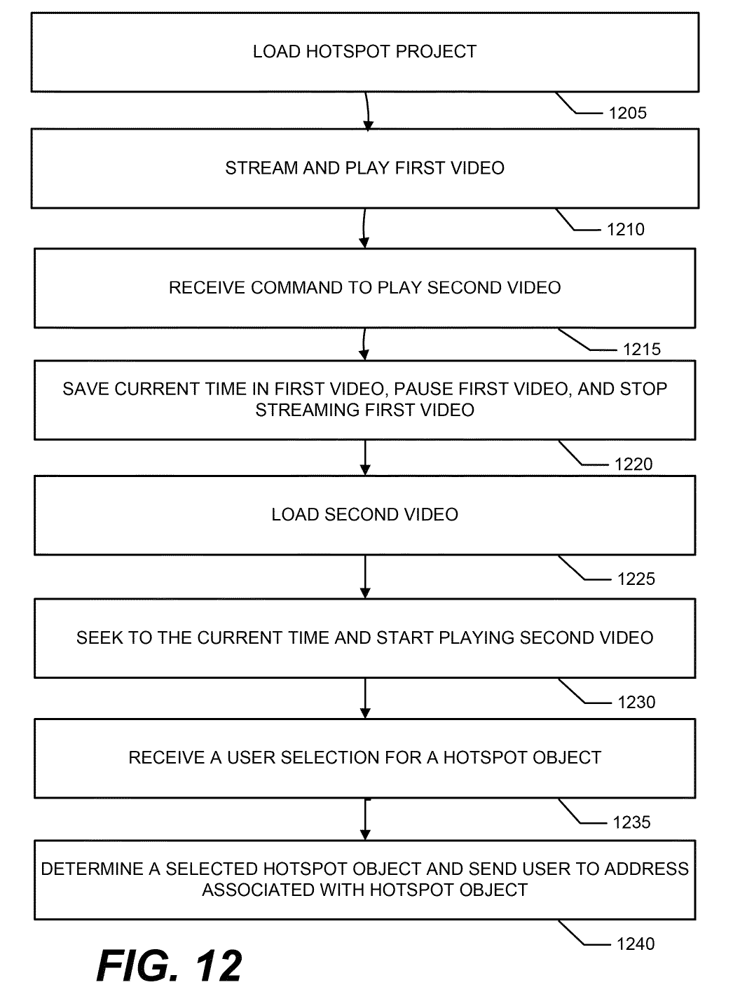

FIG. 12 is a flow chart of an example embodiment of the hotspot-enabled video player for managing a multi-angle hotspot-enabled set of videos. The video player loads a hotspot project 1105 associated with the set of videos (block 1205). In some example embodiments, the system loads a video manager that is configured to selectively stream and play a first video and a second video. Example embodiments are configured to stream or play three, four, five, six, seven, eight, nine, ten, or more videos. In some example embodiments one or more of the videos correspond to different shots or angles of the same scene or event. In one example embodiment, the hotspot project includes one or more hotspot objects, wherein at least one of the hotspot objects is associated with multiple videos. Each of the hotspot objects has one or more associated addresses and one or more associated hotspot regions. The system streams and plays the first video (block 1210). In some example embodiments, the system further buffers the first video and subsequent videos. In this way, when a user rewinds a video to replay a portion of the video, the system will not be forced to stream that segment of the video again. In some example embodiments, the user is presented with a control to switch to a second, third, or other video. In some example embodiments, when the user chooses to switch to a second video a command is sent to the video manager. In some example embodiments, the video manager runs on the client device. In other example embodiments, the video manager runs on a server. In still other example embodiments, the functionality of the video manager is divided between client and server. In one example embodiment, the system receives a command from the user to play the second video and, in response to the received command: saves a current time in the first video, pauses the first video; and the first video has not been fully streamed, the system stops streaming the first video (block 1220). The video manager then loads the second video (block 1225). In some example implementations, the video manger starts buffering the second video. In other implementations, the video manger has previously buffered all or part of the second video. The video manager seeks to the current time from the first video and begins playing the second video (block 1230). In some embodiments, the system seeks to the nearest keyframe before the current play time of the first video. In other embodiments, the systems seek to the nearest keyframe ahead of the current play time. A user may use an input device or touch input to select a location in video currently being displayed. The video manger receives a selection from the user for a hotspot object based on, for example, the user clicking or touching a location in the video area (block 1235). In response, the system determines, based on the selection from the user and the one or more hotspot regions, a selected hotspot object (block 1240). As discussed above, there may not be hotspot regions defined for the current time when the user selects a location in the video. In that case, in certain implementations, the application calculates one or more hotspot regions for the current time based on other hotspot regions for the video being displayed. In some example embodiments, the application determines an address, such as a URL, phone number, physical address, or stand alone application associated with the hotspot object. The user may be directed to the address associated with the hotspot object. In some implementations, a hotspot object is associated with two, three, or more videos. For example, a set of three or more videos of the skateboarder of FIG. 7 may show various angle of the skateboarder performing a trick. Using the hotspot editor application, for example, a user may identify hotspot regions for the skateboarder hotspot object in three videos.

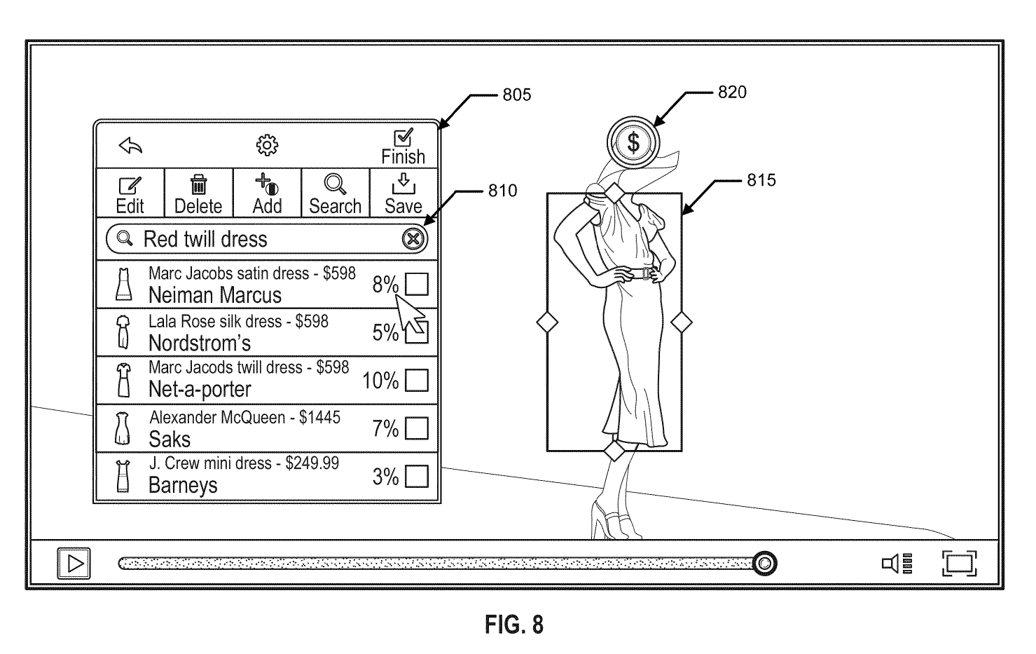

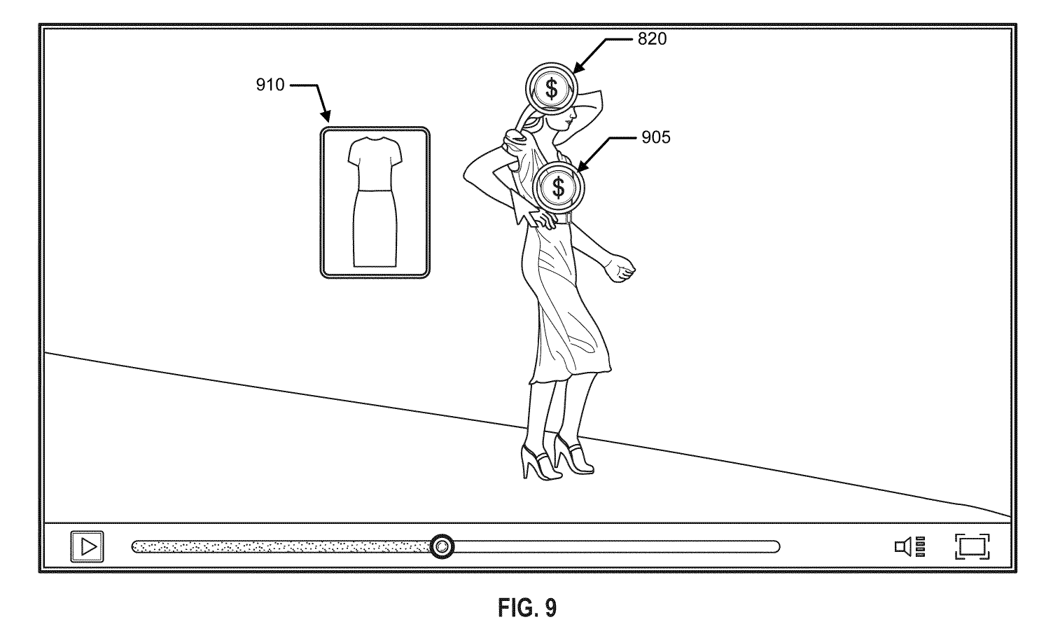

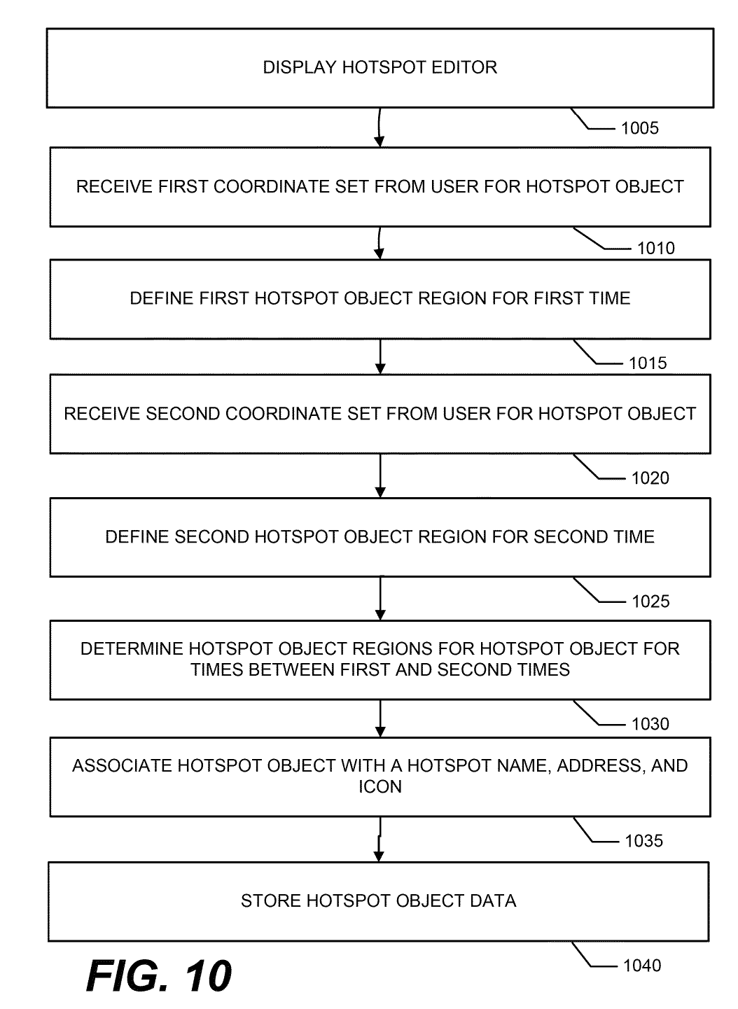

FIG. 10 is a flow chart of an example embodiment of the hotspot editor according to the present disclosure. A hotspot editor is displayed to the user (block 1005). In one example embodiment, the hotspot editor display has a video area 505, a control area 510, and a hotspot data area 515. In another example embodiment, the hotspot editor selectively displays a video area 505 and a control area 510, but not the data area 515. This may be displayed, for example, in an alternative embodiment of the hotspot editor for a mobile device when the device is oriented for a landscape display. In block 1010, the hotspot editor receives from the user a first coordinate set associated with a first hotspot object at a first time in a first video. Based on the received first coordinate set the hotspot edit defines a first hotspot object region for the first time in the first video based on the first coordinate set (block 1015). The hotspot editor then receives from the user a second coordinate set associated with the first hotspot object at a second time in the first video (block 1020). Example embodiment may receive three or more coordinate sets from the user. The hotspot editor defines a second hotspot object region for the second time in the first video based on the second coordinate set received from the user (block 1030). As described above, in certain embodiments, the hotspot editor may define a rectangle, a circle, or an irregular shape based on the user's input. The hotspot editor determines one or more hotspot object regions for times between times for which hotspot regions have been defined (block 1030). In certain example embodiments the user associates the hotspot objects with one or more of a name, an address (or URL), and an icon (block 1035). The hotspot editor stores the hotspot object data (block 1040). In some example embodiments, the hotspot editor outputs one or more still images with associated hotspot objects.

FIG. 7 is a screen shot of an example hotspot-enabled player according to the present disclosure. The player loads the hotspot objects or hotspot project associated with the video being displayed. The player is configured to receive input from the user in the form of manipulation of the playback widgets. The player is further configured to receive user inputs to select one or more hotspot objects in the video. In one example embodiment, when the user specifies by, for example clicking or touching coordinates x=522, y=132 at 2.8 seconds into the video. Using the time and coordinates selected, the player inspects the hotspot object data to determine if the specified coordinates and time match or are consistent with a defined hotspot region. In certain example embodiments, if the specified time is between two defined hotspot regions, the player determines if the location matches, or is between, locations for one or more times associated with defined hotspot regions. In certain example embodiment, if the specified time is between two defined hotspot regions, the player determines an interpolated hotspot region between two defined hotspot regions for the selected time. In one example embodiment, the video player calculates a hotspot region based on linear motion of the hotspot coordinates between two times for which hotspot regions are defined. In another example embodiment, the video player assumes elliptical motion of the coordinates defining the hotspot region. In other example embodiments, the video player inspects the contents of the video image in the existing hotspot regions to determine the location of the object being selected and uses an identification of the identified object to define a hotspot region at the selected time.

FIG. 8 is a screen shot of an example hotspot editor. At the time indicated on the progress bar, there is already a hotspot object defined for the model's hat. An icon 820 indicates that the model's hat has an associated hotspot and that it can be selected by a user. The user is defining a hotspot region 815 as a rectangle around the model's dress. A hotspot menu 805 is presented to the user. Widgets are provided to edit the hotspot, delete a hotspot, add a hotspot, search, and save. In FIG. 8, the user is adding a new hotspot for the model's dress. The user has defined the hotspot region 815 and has entered the search terms “red twill dress” in search interface 810. A search was performed to identify the search results presented below the search box. In the example shown, the search results specify a name of the product, a vendor, a price, and a commission that can be earned for sales of the item from the vendor. The user can select one or more of the search results by clicking on the boxes beside the search results. The chosen one or more results are then associated with the hotspot object.

FIG. 9 is a screenshot of a hotspot-enabled video player. Hotspot objects are defined for the model's hat and her dress. The hat object is associated with icon 820. The dress is associated with icon 905. In some example embodiments, the user that created the hotspot objects selects the placement of one or both of icons 820 and 905 and whether icons 820 and 905 should be visible at one or more times in the video. In some example embodiments, an icon associated with a hotspot region becomes visible when a user's input is over or near a hotspot region associated with the hotspot object. When the user of the video player clicks on icon 905, the player displays picture 910 of the item associated with the hotspot at icon 905. The user can then click on or otherwise select the picture 910 to be directed to an address associated with the hotspot object for the dress. For example, after clicking on the picture 910 the user may be directed to visit a vendor's website or application to obtain more information about the dress or to purchase the dress. In some example embodiments, when the user clicks an icon, such as icon 905, the video currently being displayed is paused.

Example embodiments of the systems of the present disclosure may further include an affiliate marketing system. For example, one or more hotspot objects may be associated with a corresponding one or more products or services from vendors. For example, when a user viewing a video that includes one or more hotspot objects that are associated with the vendor follows a link to visit the associated vendor, the affiliate marketing systems records that the user followed the link. In certain embodiments, when the user completes a purchase from the vendor the affiliate marketing system records details of the purchase, such as the identity of the items purchased, the number of items purchased, and the price of one or more of the items. The affiliate marketing system may further record that payment is to be received from an advertiser or vendor associated with an advertisement that was presented to the user. Example addresses associated with hot spot object may lead to a vendor's website, phone system, or an application. Other example addresses associated with hotspot object may provide a physical address or directions to a location.

In certain example implementations, an operator of an affiliate marketing system contracts with an advertiser on a pay-per-purchase basis. In other example implementations, the affiliate marketing system contracts with an advertiser on a pay-per-click basis. Pay-per-purchase generally refers to a transaction between advertiser or a vendor, on the first hand, and a marketer, on the second hand, where the advertiser charges each time a product is purchased by a user who followed a link to the vendor. In certain implementations, the purchase from must be completed within a set time from when the user followed the link to the vendor. In some example implementations, when an advertisement is displayed to the user and the user thereafter visits the vendor's website and purchases the advertised product or other products from the vendor, the retailer may pay a commission of any good or services sold. In some implementations, the time period for purchase is 7 days. In other examples the time period is 14 days. In other implementation, the time for purchase is 30 days. In other implementations, the time for purchase is between 14 and 45 days.

In the case of payment generating click-through or purchase, an example affiliate marketing system record that payment is due to a user who created the hotspot object associated with advertisement or other revenue-generating item. This payment due is typically a fraction of the overall price. In some implementations a commission is 3-10% of the amount paid. In other situations, however, a greater commission is paid by lesser-known retailers that are looking to increase their sales. Payments are sent from the vendor or advertiser to affiliate marking system at the expiration of a rebate time period. Example rebate time periods are 7 days, 14 days, or between 7 to 14 days. Some vendors give the purchasers the option to approve the product purchased once it is delivered, allowing a commission due to be released sooner. In some example embodiments a commission is credited to the user when it is received by the affiliate marketing system. In other example, payments may are made to a user once the amount of commissions reaches or exceeds a threshold. The threshold may be between $20 and $50.

In some situation, a user may sequentially follow links associated with two or more other users' hotspot objects. Each of these links sends the user to the same retailer. Example embodiments of the system determine how to divide resulting commissions between the users who created the hotspot items. In one embodiment, an entire commission is paid to the user that first created a hotspot to the product. In other example embodiments, the system splits any commission between users who created hotspot items that were followed to generate the commission. In another example embodiment, the user associated with the first hotspot item for which a link was followed that generated the commission receives the commission. In another example embodiment, the user associated with the last hotspot item for which a link was followed that generated the commission receives the commission. In another example embodiment, the commission is credited such that the first user to create the hotspot object receives more than the second user to create the hotspot link. In one example embodiment where the user followed two hotspot item links to the same item, the first user to create the hotspot item would receive 80% and the user associated with the second hotspot item would receive 20%. Alternatively, the split may be reversed, such that a user that created the second hotspot item receives more than the user who created the first hotspot object. In other example embodiments, any commission is shared with the application or website that hosts audio visual content that is displayed to the user.

Other implementations feature alternative arrangements. For example, in one example embodiment the first user to create the hotspot object that was followed to create the commission and the host of the audiovisual content split the proceeds generated by the content. In another implementation, the host of the audiovisual content is also the creator of the hotspot object and receives all of the commission. For example a vendor may send data feeds full of product pictures. In one example implementation, if the host of audiovisual content takes the pictures from these feeds and tags on their own they receive full commission.

In one example implementation, a user provides an image or a video to the system using a browser or using a stand-alone application. For example, the user may take a photograph or video using a camera or smart phone. The user places an icon on a hotspot location or on a hotspot region in the photograph or video. The user can then associate one or more addresses with the hotspot location or hotspot region. In some example implementations, the user searches on keywords in an application, which, in turn send the keywords to a server. The server, in turn searches one or more affiliate services for products or services that match the searched one or more keywords. If results are found, the results are sent to the server. In some example implementations, affiliate services respond with JSON data feeds or XML data to the server. Example data feeds include one or more of product names, images, addresses, and prices. The server shows a result list of products to the user. The user may use a standalone application to perform this process. In some implementations, the stand-alone application keeps the result list in memory. The user selects one or more products from the search results that the user wants to associate with the hotspot location or hotspot region. In some implementations, the application gets information about the selected product from memory, such as one or more of the product name, image, link to buy, and price. In certain implementations, a tagger id parameter to identify the user who created the hotspot is associated with the hotspot location or object. In some implementations, a tagger id parameter to identify the user who created the hotspot is integrated into an address associated with the hotspot object. In some implementations, the application sends information about the tagged items to a server. The server stores the received this information about the hotspot object, such as one or more of the name, image, address, price, and hotspot locations, and saves the information to a database or to one or more files. A second user is shown the images or video. In certain implementations, when the second user's input device is over or when a user clicks on a tagged icon or hotspot region, an indication is sent to the server. In some example implementations the application retrieves data related to hotspot items from the database and shows one or more details of the data to the second user. For example, the second user may be shown one or more of the name, image, price, and address or link to purchase the item. In some implementations, when the second user clicks on an image or name associated with the hotspot item, the second user is redirect to webpage or other address to get further information about or purchase a product associated with the hotspot object. In some example embodiments, when the second user buys the product or service associated with the hotspot object, an affiliate service notifies the server of the sale. A report from the affiliate services may include information about product sold including affiliates, commission amount, report date, and identification of the user or users who created the hotspot object associated with the sale. Certain implementations allow the user to get a report on activity related to the user's hotspot objects.

In certain implementations, two or more hotspot objects may be placed into a competition to rank the respective hotspot object. For example, hotspot objects with the same or similar titles may be placed into competition. For example, a competition may decide a ranking of slam dunks or cutest cats. Hotspot objects may be arranged into brackets. Users may view the videos or images associated with the hotspot objects and vote on each competitor in the bracket. For example, a bracket may feature 32 cute cats. The user may view videos of the cats and vote for one video in each of the brackets. This system may be referred to as Bracketology. For example, Bracketology performs the mathematical equations to allow for any number of entrants to be formed into a bracket, and have the same functionality as that found in the other systems and methods (e.g., preview video, hierarchical winners being sent onto the glossary, all on a scheduled basis). An example of some rules for a Bracketology implementation follows. For example, in the case of competition with four entries, two entrants compete in tow brackets and the winners advance to compete against each other. When the number of competitor is such that a normal bracket is not possible, the system creates entry competitions for slots in the bracket.

A notification may be sent to the user so the user can re-consider placement in the user's current bracket. If the user chooses for this task to be automated the system can even re-calculate the products positioning based upon the new improvements of the next generation model.

For example, a user has selected a number of cars and chooses to use the bracket method to decide the winner. But, in some example implementations when time has passed, a car that was ranked third now is represented by a new model of the car. The bracket will set off an alert in which the user can come and check out the changes and decide if the changes are enough to move it up in the standings. Alternatively, if the user chose automated and selected key characteristics that made up her decision previously (e.g. gas mileage, cost, etc), the system can read those decisions and determine how the new entrant matches up to these requirements, updating the brackets accordingly.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for managing hotspot objects associated with one or more videos, comprising:
displaying a hotspot editor to a user, the hotspot editor comprising a video area, a control area, and a hotspot data area;
receiving from the user a first coordinate set associated with a first hotspot object at a first time in a first video;
defining a first hotspot object region for the first time in the first video based on the first coordinate set;
receiving from the user a second coordinate set associated with the first hotspot object at a second time in the first video;
defining a second hotspot object region for the second time in the first video based on the second coordinate set;
determining one or more hotspot object regions for the first hotspot object for one more times between the first time and the second time;
associating the first hotspot object with a first address;
storing data associated with the for the first hotspot object, wherein the data associated with the first hotspot object includes the hotspot regions and the associated first address.

2. The method of claim 1, wherein receiving from a user a first coordinate set associated with a first hotspot object at a first time in a video, comprises:
receiving two coordinates from the user based on the users touching the video area, wherein the two coordinates define a rectangle.

3. The method of claim 1, further comprising:
receiving from the user a first coordinate set associated with a second hotspot object at a first time in a video;
defining a second hotspot object region for the first time in the video based on the first coordinate set;
receiving from the user a second coordinate set associated with the second hotspot object at a second time in the video clip;
defining a second hotspot object region for the second time in the video based on the second coordinate set;
determining one or more hotspot object regions for the second hotspot object for one more times between the first time and the second time;
associating the second hotspot object with a second address;
storing data associated with the for the first hotspot object, wherein the data associated with the first hotspot object includes the hotspot regions and the associated first address.

4. The method of claim 1, further comprising:
associating the first hotspot object with a first term.

5. The method of claim 1, further comprising:
associating the first hotspot object with a first title.

6. The method of claim 1, further comprising:
receiving from the user a third coordinate set associated with the first hotspot object at a third time in the video clip, wherein the third time is between the first time and the second time;
altering the one or more hotspot object regions for the first hotspot object for one more times between the first time and the second time to account for the received third coordinate set.

7. The method of claim 1 wherein each of the first coordinate set and the second coordinate set define a rectangle.

8. The method of claim 1, further comprising:
associating the first hotspot object with a hotspot icon, wherein the icon is displayed during playback of the video.

9. A system for managing hotspot objects associated with a video, comprising:
one or more processors;
a memory, including one or more executable instructions that, when executed, cause the one or more processors to:
display a hotspot editor to a user, the hotspot editor comprising a video area, a control area, and a hotspot data area;
receive from the user a first coordinate set associated with a first hotspot object at a first time in a video;
define a first hotspot object region for the first time in the video based on the first coordinate set;
receive from the user a second coordinate set associated with the first hotspot object at a second time in the video clip;
define a second hotspot object region for the second time in the video based on the second coordinate set;
determine one or more hotspot object regions for the first hotspot object for one more times between the first time and the second time;
associate the first hotspot object with a first address;
store data associated with the for the first hotspot object, wherein the data associated with the first hotspot object includes the hotspot regions and the associated first address.

10. A method for managing a multi-angle hotspot-enabled set of videos, comprising:
loading a video manager, wherein the video manager is configured to selectively stream and play a first video and a second video;
loading a hotspot project, the hotspot project including one or more hotspot objects, wherein at least one of the hotspot objects is associated with both the first video and the second video and wherein each of the hotspot objects has an associated address and one or more associated hotspot regions;
receiving and playing the first video from a server;
receiving a command from the user to play the second video and, in response to the command:
saving a current time in the first video;
pausing the first video; and
if the first video has not been fully streamed, stopping the streaming the first video;
loading the second video;
seeking to the current time;
playing the second video;
receiving a selection from the user for a hotspot object;
determining, based on the selection from the user and the one or more hotspot regions, a selected hotspot object; and
sending the user to the address associated with the selected hotspot object.

11. The method of claim 10, wherein the first video and the second video are different angle shots of the same scene.

12. The method of claim 10, where the video manager is further configured to selectively stream and play a third video and wherein at least one of the hotspot objects is associated with the first video, the second video, and the third video.

13. The method of claim 12, wherein the first video, the second video, and the third video are different angle shots of the same scene.

14. The method of claim 10, further comprising:
buffering the first and second videos.
